(19) United States
(12) Patent Application Publication
(10) Pub. No.: US 2014/0380325 A1
(43) Pub. Date: Dec. 25, 2014

(54) MULTIPROCESSOR SYSTEM

(71) Applicant: PANASONIC CORPORATION, Osaka (JP)

(72) Inventor: Tetsu HOSOKI, Tokyo (JP)

(21) Appl. No.: 14/477,625

(22) Filed: Sep. 4, 2014

Related U.S. Application Data
(63) Continuation of application No. PCT/JP2013/000495, filed on Jan. 30, 2013.

(30) Foreign Application Priority Data
Mar. 6, 2012 (JP) 2012-049689

(51) Int. Cl. G06F 9/48

(52) U.S. Cl. CPC G06F 9/4881
USPC 718/102

(57) ABSTRACT

A multiprocessor system includes: a logical processor assigned to any one of physical processors to be executed on the multiprocessor system; and a scheduler managing the assignment of the logical processor to one of the first kind physical processor and the second kind physical processor. The logical processor has a flag for holding information indicating an internal state of the logical processor. The scheduler determines the assignment of the logical processor to one of the first kind physical processor and the second kind physical processor, based on presence or absence of an occurrence of a predetermined event and the information held in the flag.

### CROSS REFERENCE TO RELATED APPLICATIONS

This is a continuation application of PCT International Application No. PCT/JP2013/000495 filed on Jan. 30, 2013, designating the United States of America, which is based on and claims priority of Japanese Patent Application No. 2012-049689 filed on Mar. 6, 2012. The entire disclosures of the above-identified applications, including the specifications, drawings and claims are incorporated herein by reference in their entirety.

### FIELD

One non-limiting and exemplary embodiment relates to multiprocessor systems. In particular, the embodiment relates to a multiprocessor system including multiple processors which have a mutually compatible instruction and each of which is different in kind.

### BACKGROUND

There is a multiprocessor system including multiple processors employing a single instruction set architecture and each being different in kind, in order to achieve both high processing capability and low power consumption. Recently, such a multiprocessor system is adopted as processors to be included in handheld terminal devices such as tablet PCs (see Patent Literature 1 (PTL 1) and Non-Patent Literature 1 (NPL 1), for example).

PTL 1 discloses a technique to implement a multiprocessor system including multiple processor cores which have a single instruction set architecture and each of which employs a different technique to issue an instruction.

Moreover, NPL 1 discloses a multiprocessor system which has a single instruction set architecture and includes multiple processor cores each different in manufacturing process and maximum operating frequency.

### CITATION LIST

### Patent Literature

### PTL 1

Japanese Patent No. 4241921

### Non Patent Literature

### NPL 1

Whitepaper “Variable SMP-A Multi-Core CPU Architecture for Low Power and High Performance”, NVIDIA, 2011, http://www.nvidia.co.jp/content/PDF/tegra_white_papers/Variable-SMP -A-Multi-Core-CPU-Architecture-for-Low-Power-and-High-performance-v1.1.pdf.

### SUMMARY

### Technical Problem

The multiprocessor systems disclosed in the conventional techniques, however, cannot sufficiently achieve both high processing capability and low power consumption.

One non-limiting and exemplary embodiment provides a multiprocessor system which achieves both high processing capability and low power consumption.

### Solution to Problem

A multiprocessor system according to an aspect of one non-limiting and exemplary embodiment includes physical processors including at least one each of a first kind physical processor and a second kind physical processor, the physical processors having at least one mutually compatible instruction. The multiprocessor system includes: a logical processor which is assigned to any one of the physical processors to be executed on the multiprocessor system; and a scheduler which manages the assignment of the logical processor to one of the first kind physical processor and the second kind physical processor. The logical processor has a flag for holding information indicating an internal state of the logical processor, and the scheduler determines the assignment of the logical processor to one of the first kind physical processor and the second kind physical processor, based on presence or absence of an occurrence of a predetermined event and the information held in the flag.

It is noted that one non-limiting and exemplary embodiment can be implemented not only as the above-described multiprocessor system but also as a multiprocessor controlling method employing characteristic units included in the multiprocessor system in the form of steps, and as a program to cause a computer to execute the characteristic steps. As a matter of course, such a program may be distributed via a recording medium such as a Compact Disc Read Only Memory (CD-ROM) and a transmission medium such as the Internet.

### Advantageous Effects

One non-limiting and exemplary embodiment provides a multiprocessor system which achieves both high processing capability and low power consumption.

### BRIEF DESCRIPTION OF DRAWINGS

These and other objects, advantages and features of the invention will become apparent from the following description thereof taken in conjunction with the accompanying drawings that illustrate a specific embodiment of the present disclosure.

[FIG. 1]

FIG. 1 represents a block diagram exemplifying a structure of a multiprocessor system according to an embodiment.

[FIG. 2]

FIG. 2 represents a state transition diagram exemplifying a transition of an internal state recorded on a logical processor state register according to the embodiment.

[FIG. 3]

FIG. 3 represents a timing diagram exemplifying how logical processors are assigned to physical processors according to the embodiment.

[FIG. 4]

FIG. 4 represents a diagram exemplifying transition states of logical processors according to the embodiment.

[FIG. 5]

FIG. 5 represents a block diagram exemplifying a structure of a multiprocessor system according to a modification of the embodiment.

### DESCRIPTION OF EMBODIMENT

### Embodiment

A multiprocessor system according to an implementation of one non-limiting and exemplary embodiment includes physical processors including at least one each of a first kind physical processor and a second kind physical processor, the physical processors having at least one mutually compatible instruction. The multiprocessor system includes: a logical processor which is assigned to any one of the physical processors to be executed on the multiprocessor system; and a scheduler which manages the assignment of the logical processor to one of the first kind physical processor and the second kind physical processor. The logical processor has a flag for holding information indicating an internal state of the logical processor, and the scheduler determines the assignment of the logical processor to one of the first kind physical processor and the second kind physical processor, based on presence or absence of an occurrence of a predetermined event and the information held in the flag.

With the above features, the multiprocessor system can recognize the timing of the resumption of a logical processor in a wait state or a sleep state due to an event. As a result, the multiprocessor system can select the kind of a physical processor to which a logical processor is to be assigned, based on details of the processing that the logical processor execute after the resumption. This makes it possible to switch between physical processors one of which excels in high processing capability and the other of which excels in low power consumption, when the logical processor resumes. As a result, the multiprocessor system can achieve both high processing capability and low power consumption.

The logical processor may further include a selecting register which stores information indicating one kind out of the first kind physical processor and the second kind physical processor, and the scheduler may determine the assignment of the logical processor to one of the first kind physical processor and the second kind physical processor, based on presence or absence of a predetermined event, the flag, and the information stored in the selecting register.

With the above features, the multiprocessor system can determine the kind of a processor to which a resumed logical processor is to be assigned, with reference to a processor kind stored in the selecting register.

The scheduler may determine the assignment of the logical processor to one of the first kind physical processor and the second kind physical processor, in the case where (i) the predetermined event occurs and (ii) the information held in the flag included in the logical processor indicates that the assignment of the logical processor to the any one of the physical processors is canceled by the logical processor executing at least one of a sleep instruction and a wait instruction.

Such features allow the multiprocessor system to achieve both high processing capability and low power consumption with the timing of the resumption of a logical processor under at least one of a sleep instruction and a wait instruction.

The scheduler may determine, based on the information stored in the selecting register, the assignment of the logical processor to one of the first kind physical processor and the second kind physical processor, in the case where (i) the predetermined event occurs and (ii) the information held in the flag included in the logical processor indicates that the assignment of the logical processor to the any one of the physical processors is canceled by the logical processor executing at least one of a sleep instruction and a wait instruction.

The scheduler may determine the assignment of the logical processor to one of the first kind physical processor and the second kind physical processor having the one kind indicated in the selecting register, in the case where (i) the predetermined event occurs and (ii) the information held in the flag included in the logical processor indicates that the assignment of the logical processor to the any one of the processors is canceled by the logical processor executing at least one of the sleep instruction and the wait instruction.

Such features allow designation of information to be recorded in the selecting register, which contributes to designating the kind of a physical processor to which a resuming logical processor under at least one of a sleep instruction and a wait instruction is assigned.

Before the embodiment is described, discussed first in detail are the problems of conventional arts.

A symmetric multiprocessor—that includes multiple physical processors having the same physical structure—employs a processing technique which matches the processor's high performance. Hence even though the number of physical processors to run can be changed, the physical processors inevitably suffer from effects such as leakage power. In contrast, a recently developed multiprocessor includes multiple physical processors employing the same instruction set but each being different in kind. Here, that “the physical processors are each different in kind” means, for example, that each of the physical processors is different in maximum operating frequency and pipeline structure. The details shall be described later.

Studied here is a case where, in a multiprocessor system, each of the physical processors is assigned to logical processors by time sharing in order to concurrently execute as many threads as possible. Here, when a thread executed on a logical processor goes in a sleep (or wait) state, the assignment of a physical processor to the thread-executing logical processor is once canceled. After that, as soon as the thread in the sleep (or wait) state resumes, the logical processor has a physical processor assigned again.

When a logical processor in a sleep (or wait) state, which has once been out of an executing state, executes processing after resumption, the executed processing could be different before and after the sleep (or wait) state. For example, when going into the sleep state to wait for an event, the logical processor is required to achieve the same response speed before and after the resumption. In some cases, one of which is when the processing would end without maxing out an assigned throughput, however, the processing after the resumption can be executed by another physical processor whose performance is lower than that of the physical processor that was previously executing the processing. When the processing ends without maxing out the assigned throughput as described above, the same physical processor does not have to resume the processing. For example, another physical processor having a lower maximum operating frequency may resume the processing.

For multiprocessor systems in the conventional arts, however, no technique is studied which involves re-assigning a logical processor to a physical processor when the logical processor goes out of a sleep (or wait) state and resumes. In other words, for the multiprocessor systems in the conventional arts, no technique is studied which involves determining which logical processor in resumption should be assigned to which physical processor. As a result, even though a physical processor which excels in low power consumption can handle calculation under normal conditions, the multiprocessors in conventional arts would always assign a logical processor to another physical processor which is faster and requires more power consumption.

One non-limiting and exemplary embodiment relates to a multiprocessor system. When a logical processor, which suspends processing to wait for an event, resumes the processing, the multiprocessor system assigns, without an intervention of an operating system (OS), the logical processor to a physical processor which consumes lower power. As a result, the multiprocessor system implemented in the embodiment can achieve both high processing capability and low power consumption.

Described hereinafter in detail is an embodiment according to an implementation of the present disclosure, with reference to the drawings. It is noted that the embodiment below is a specific and beneficial example of the present disclosure. The numerical values, shapes, constituent elements, arrangement positions of and connecting schemes between the constituent elements, steps, and an order of the steps all described in the embodiment are examples, and shall not limit the present disclosure. The present disclosure shall be defined by claims. Hence, among the constituent elements in the embodiment, those not described in an independent claim representing the most generic concept of the present invention are not necessarily required to achieve the objects of the present disclosure; however, such constituent elements are introduced to implement a preferable form of the present disclosure.

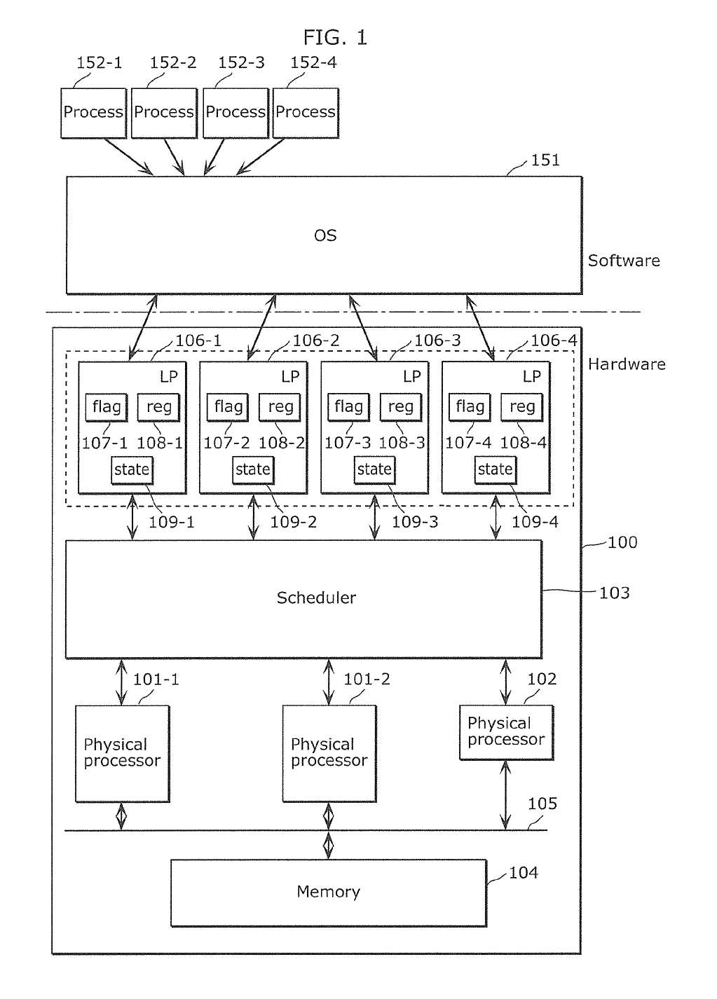

FIG. 1 illustrates a block diagram of a multiprocessor system according to an embodiment representing an implementation of the present disclosure. The multiprocessor system according to the embodiment includes at least one each of a first kind physical processor and a second kind physical processor. Here the first kind physical processor and the second kind physical processor have at least one mutually compatible instruction. In other words, the first kind physical processor and the second kind physical processor have instruction sets which include at least one instruction that is mutually compatible between the two physical processors. Here the embodiment is applicable to a program which runs only with the mutually compatible instruction. It is noted that when the instruction sets for the first kind physical processor and the second kind physical processor are the same, the embodiment is applicable to all the programs that run on the physical processors.

Specifically, as illustrated in FIG. 1, a multiprocessor system 100 includes physical processors 101-1, 101-2, and 102, a scheduler 103, a memory 104, and logical processors 106-1 to 106-4.

The physical processors 101-1 and 101-2 are of the same kind. For example, the physical processors 101-1 and 101-2 are the same in manufacturing process and maximum operating frequency. Here the physical processors 101-1 and 101-2 are classified into a processor kind A. It is noted that a physical processor in the processor kind A is equivalent to the first kind physical processor in the present disclosure.

The physical processor 102 is made with a manufacturing process technique which is different from that of the physical processors 101-1 and 101-2. As a result, the physical processor 102 is higher than the physical processors 101-1 and 101-2 in maximum operating frequency. Here the physical processor 102 is classified into a processor kind B. It is noted that a physical processor in the processor kind B is equivalent to the second kind physical processor in the present disclosure.

For each of the physical processors 101-1 and 101-2, the scheduler 103 determines a logical processor to be processed by the physical processor, based on information on the logical processors 106-1 to 106-4. Specifically, the scheduler 103 determines that which one of the logical processors 106-1 to 106-4 is selected and assigned to each of the physical processors. Moreover, the scheduler 103 assigns or saves (cancels the assignment) each of the logical processors 106-1 to 106-4 to or in the physical processors 101-1 and 101-2, and the physical processor 102. In other words, the scheduler 103 manages the assignment of a logical processor to one of the first kind physical processor and the second kind physical processor.

The memory 104 is connected to each of the physical processors 101-1, 101-2, and 102 via a shared memory bus 105. In other words, the memory 104 is shared among the physical processors 101-1, 101-2, and 102.

It is noted that the memory 104 may be implemented in the form of any given storage unit such as a Random Access Memory

(RAM), a Read Only Memory (ROM), and a Static Random Access Memory (SRAM).

The logical processors 106-1 to 106-4 are each assigned to any one of the physical processors to be executed on the multiprocessor system 100.

The logical processors 106-1 to 106-4 respectively include status holding flags 107-1 to 107-4, resumption processor selecting registers 108-1 to 108-4, and logical processor state registers 109-1 to 109-4. Here information stored in the following constituent elements; namely the status holding flags 107-1 to 107-4, the resumption processor selecting registers 108-1 to 108-4, and the logical processor state registers 109-1 to 109-4, is referred to as processor context information.

It is noted that the status holding flag is also referred to as flag. The resumption processor selecting register is also referred to as selecting register.

The status holding flags 107-1 to 107-4 hold information indicating internal states of the logical processors.

More specifically, the status holding flag 107-1 is set when the logical processor 106-1 executes a wait instruction (or a sleep instruction). After that, when the logical processor 106-1 is assigned to any one of the physical processors 101-1, 101-2, and 102, the status holding flag 107-1 is reset. Similarly, when each of the logical processors 107-2 to 107-4 executes a wait instruction (or a sleep instruction), a status holding flag for the logical processor is set. After that, when the logical processor is assigned to any one of the physical processors, the status holding flag for the logical processor is reset.

It is noted that setting a status holding flag is, for example, to store a predetermined value, such as a “1” and a “true”, in the status holding flag. Furthermore, resetting a status holding flag is, for example, to store a predetermined value which is different from the set value, such as a “0” and a “false”, in the status holding flag. Based on the presence or absence of a predetermined event and the information held in a flag, the scheduler 103 determines the assignment of a logical processor to one of the first kind physical processor and the second kind physical processor. An exemplary predetermined event may be an event to cancel the sleep state or the wait state. The details of the operation shall be described later.

The resumption processor selecting registers 108-1 to 108-4 store information indicating the kind of the first kind processor or of the second kind processor. Specifically, each of the resumption processor selecting registers 108-1 to 108-4 stores information indicating the kind of a physical processor to be assigned to a logical processor having a status holding flag corresponding to the resumption processor selecting register when the corresponding status holding flag is reset. For example, the scheduler 103 stores the processor kind A in a resumption processor selecting register in order to assign one of the physical processors 101-1 and 101-2. Moreover, the scheduler 103 stores the processor kind B in a resumption processor selecting register in order to assign the physical processor 102.

In other words, based on the presence or absence of a predetermined event, a flag, and information stored in a resumption processor selecting register, the scheduler 103 determines the assignment of a logical processor to one of the first kind physical processor and the second kind physical processor. The details of the operation shall be described later.

The logical processor state registers 109-1 to 109-4 respectively hold an internal state of the logical processors 106-1 to 106-4.

An operation system (OS) 151 determines that which one of processes 152-1 to 152-4 is assigned to which one of the logical processors 106-1 to 106-4. Based on the determination result, the OS 151 assigns each of the processes 152-1 to 152-4 to one of the logical processors 106-1 to 106-4.

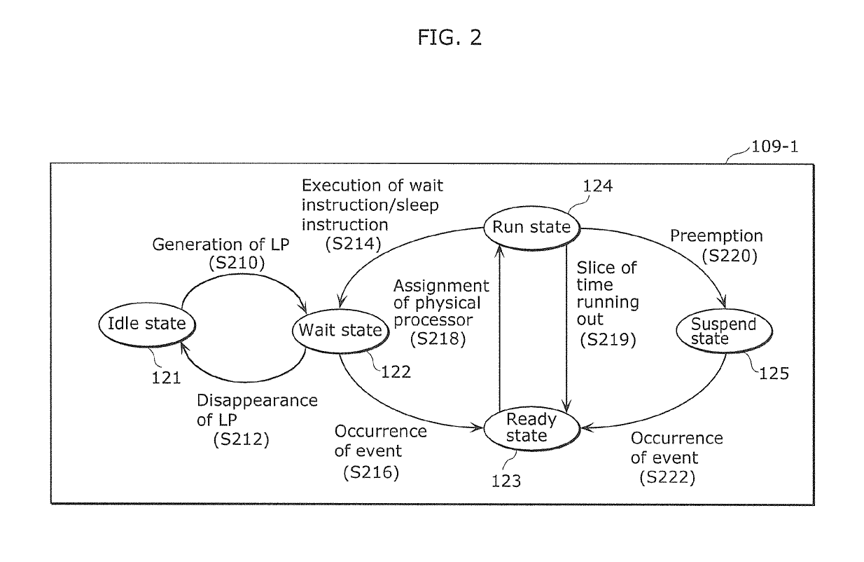

Described next is an internal state of a logical processor held in a logical processor state register, with reference to FIG. 2.

FIG. 2 illustrates a transition of an internal state of the logical processor 106-1 recorded on the logical processor state register 109-1 according to the embodiment.

As illustrated in FIG. 2, the internal state of the logical processor 106-1, indicated in the logical processor state register 109-1, transits from an idle state 121 to a wait state 121 when the logical processor 106-1 is generated in the idle state 121 (S210). When a wait cancel event occurs in the wait state 122, the internal state changes from the wait state 122 to a ready state 123 (S216). When the logical processor 106-1 is assigned in the ready state 123 by the scheduler 103 to any one of the physical processors 101-1, 101-2, and 102 (S218), the internal state changes from the ready state 123 to a run state 124.

In the run state 124, when the scheduler 103 is notified of a request for assigning a logical processor having a higher priority, the scheduler 103 preempts the internal state of the logical processor 106-1 so that the internal state changes from the run state 124 to a suspend state 125 (S220). When the logical processor 106-1 spends a predetermined time quantum value, the physical processor assigned by the scheduler 103 is once released and the internal state changes from the run state 124 to the ready state 123 (S219). Then, when a predetermined time elapses, the logical processor 106-1 is assigned to a physical processor again (S218). Here, the multiprocessor system 100 according to the embodiment refers to the resumption processor selecting register 108-1 and assigns the logical processor 106-1 to a physical processor whose kind is designated by the resumption processor selecting register 108-1.

In the multiprocessor system 100, when a resume event occurs in the logical processor 106-1 in the suspend state 125, the suspend state 125 changes to the ready state 123 (S222).

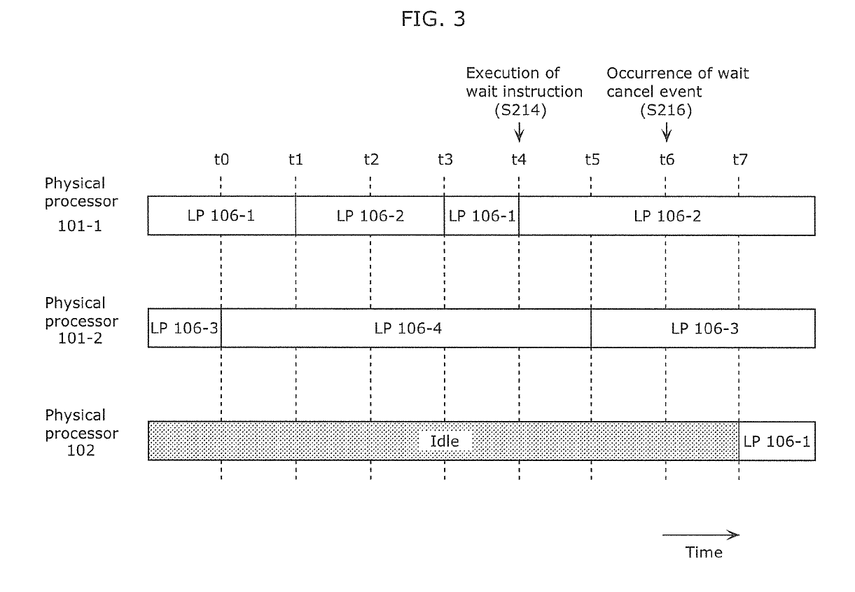

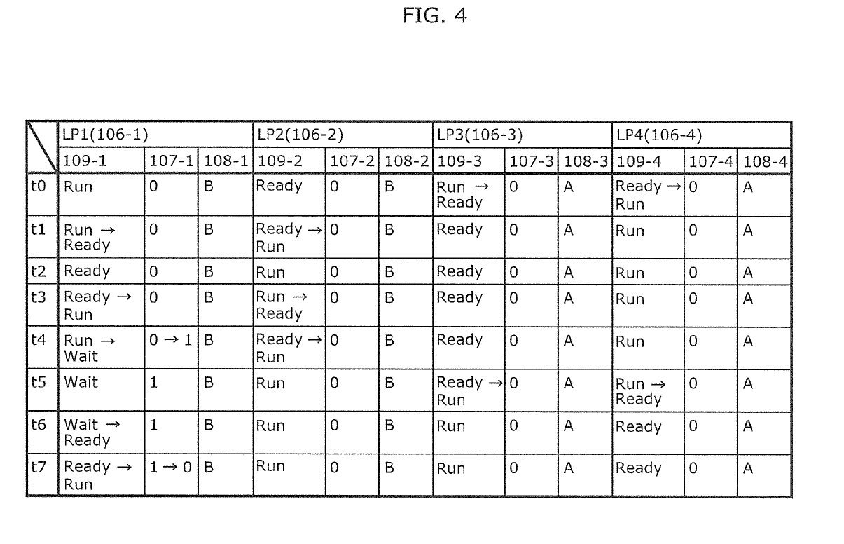

Described next is how to assign a logical processor to a physical processor, with reference to FIGS. 3 and 4.

FIG. 3 represents a timing diagram exemplifying how logical processors are assigned to physical processors. FIG. 4 represents a diagram illustrating transition of the internal states in the logical processors at each time (t0 to t7) in FIG. 3.

When a predetermined quantum value is spent, a wait (sleep) cancel event occurs (Step S216 in FIG. 2), or a resume event occurs (S222 in FIG. 2) for each of the logical processors, the scheduler 103 resumes the logical processor. Specifically, the scheduler 103 starts scheduling to assign a physical processor to the logical processor. Here the scheduler 103 determines whether or not each of the logical processor state registers 109-1 to 109-4 is in the ready state 123. If the logical processor state registers 109-1 to 109-4 are in the ready state 123, the scheduler 103 further determines whether or not a status holding flag in the logical processor is set. If the status holding flag is set, the scheduler 103 determines whether or not the logical processor can be assigned to a physical processor whose kind is indicated in a resumption processor selecting register included in the logical processor. If the result of the determination indicates that the logical processor can be assigned, the scheduler 103 determines to assign the logical processor to the physical processor whose kind is indicated in the resumption processor selecting register.

As described above, in the case where (i) a predetermined event occurs and (ii) information held in a flag included in a logical processor indicates that assignment of the logical processor to any one of the physical processors is canceled by the logical processor executing at least one of a sleep instruction and a wait instruction, the scheduler 103 determines the assignment of the logical processor to one of the first kind physical processor and the second kind physical processor.

Specifically, in the case where (i) a predetermined event occurs and (ii) information held in a flag included in a logical processor indicates that assignment of the logical processor to one of the first kind processor and the second kind processor is canceled by the logical processor executing one of a sleep instruction or a wait instruction, the scheduler 103 determines the assignment of the logical processor to any one of the physical processors, based on information indicated in a resumption processor selecting register.

More specifically, in the case where (i) a predetermined event occurs and (ii) information held in a flag indicates that assignment of the logical processor to the any one of the processors is canceled by the logical processor executing one of a sleep instruction or a wait instruction, the scheduler 103 determines that the logical processor is assigned to one of the first kind physical processor and the second kind physical processor having the kind indicated in the resumption processor selecting register. It is noted that the scheduler 103 may further add a predetermined priority and processing load to the information used to determine the assignment.

The assignment shall be described more specifically, with reference to FIGS. 3 and 4. At each of the times t0 to t5, the logical processors -which have been assigned to either the physical processor 101-1 or the physical processor 101-2 until the times-spend predetermined quantum values. As a result, when a logical processor spends its quantum value, the scheduler 103 cancels the assignment of the logical processor to a physical processor. After that, the scheduler 103 assigns, to the physical processor, another logical processor which has been into a ready state until then. Here the status holding flags 107-1 to 107-4 are not updated.

With reference to FIG. 3, for example, the logical processor (also referred to as LP) has been assigned to the physical processor 101-2 until the time t0. The assignment is, however, canceled at the time t0. After that, the logical processor 106-4 is assigned to the physical processor 101-2. Moreover, with reference to FIG. 4, the information—that is indicated in the logical processor state register 109-3 included in the logical processor 106-3—is updated at the time t0 from “run” to “ready”. Simultaneously, the information—that is indicated in the logical processor state register 109-4 included in the logical processor 106-4—is updated at the time t0 from “ready” to “run”. The values held in the status holding flags 107-3 and 107-4 are kept “0”, and thus are not set.

After that, at the time t4, the logical processor 106-1 executes a wait instruction. As a result, the scheduler 103 cancels the assignment of the logical processor 106-1 to the physical processor 101-1. Here, as illustrated in FIG. 4, the information—that is indicated in the logical processor state register 109-1 included in the logical processor 106-1—is updated from “run” to “wait”. Furthermore, the status holding flag 107-1 is set to “1”. After that, at the time t6, a cancel event occurs to the wait instruction executed by the logical processor 106-1. As a result, the information indicated in the logical processor state register 109-1 is updated from “wait” to “ready”.

With reference to the facts that (i) the internal state of the logical processor 106-1 becomes the ready state due to the occurrence of the cancel event to the wait instruction, (ii) the status holding flag 107-1 is “set”, and (iii) the resumption processor selecting register 108-1 has a value designated as “B”, the scheduler 103 checks an idle state of the physical processor that belongs to the processor kind B. As a result, at the time t7, the scheduler 103 determines that a logical processor can be assigned to the physical processor 102, and thus assigns the logical processor 106-1 to the physical processor 102.

Hence, when a logical processor, which executes a wait instruction or a sleep instruction and its assignment to the physical processor, is once canceled, resumes, the scheduler 103 can designate a processor to which the logical processor resumes. Specifically, the kind of a physical processor to which the logical processor resumes can be automatically changed without an intervention of an OS, depending on conditions such as whether a fast response is required for processing after resumption and whether the required processing capability is not high. More specifically, if a high processing speed is required for the processing after the resumption, a physical processor to be designated for the assignment after the resumption is as fast in processing speed as a physical processor to which the logical processor was assigned when the logical processor executed the wait instruction or the sleep instruction. In contrast, if a high processing speed is not required for the processing after the resumption, a physical processor to be designated for the assignment after the resumption is slower in processing speed and smaller in power consumption than a physical processor to which the logical processor was assigned when the logical processor executed the wait instruction or the sleep instruction. Such features make it possible to switch between a physical processor which excels in high processing capability and a physical processor which excels in low power consumption when a logical processor resumes. As a result, the multiprocessor system can achieve both high processing capability and low power consumption.

It is noted that the kind of a processor indicated in a resumption processor selecting register may be written in a ROM and the like when the multiprocessor system is manufactured. The kind of a processor may be determined or updated by the OS 151 in accordance with a process to be assigned to a logical processor. Moreover, a user may select the kind via the OS 151.

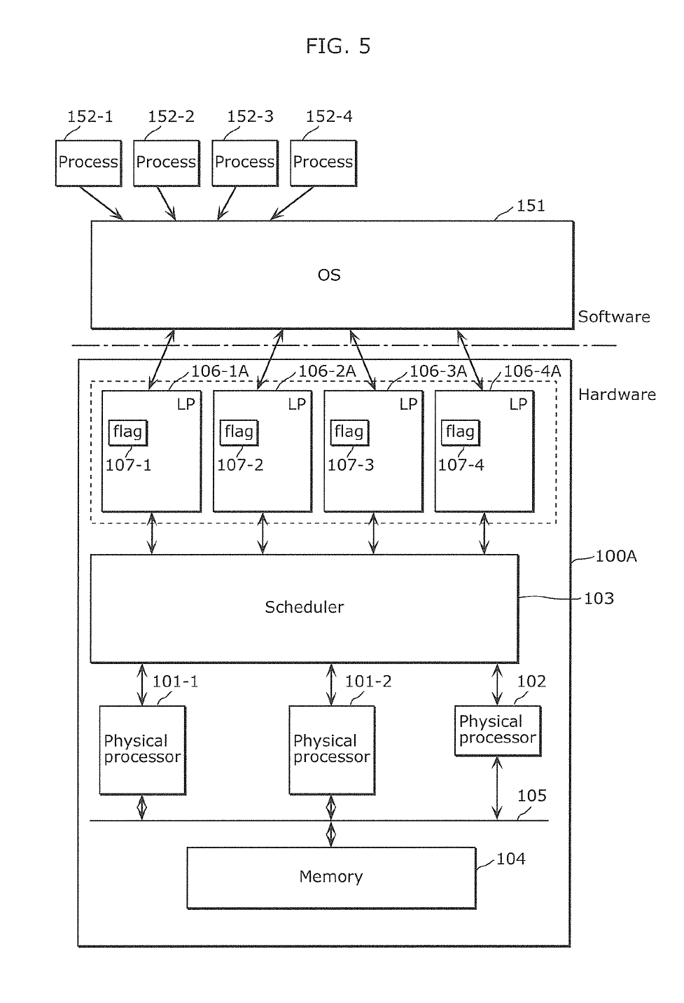

It is noted that each of the logical processors included in the multiprocessor system 100 according to the embodiment may omit at least one of a resumption processor selecting register and logical processor state register. For example, as a multiprocessor system 100A illustrated in FIG. 5, the logical processors 106-1A to 106-4A may only include wait state holding flags 107-1 to 107-4. Here the multiprocessor system 100A includes a common register (not shown) which is equivalent to a resumption processor selecting register and a logical processor state register and operates among multiple logical processors. Hence the multiprocessor system 100A achieves an effect similar to that of the multiprocessor system 100. In addition, when a logical processor under a sleep instruction or a wait instruction resumes, the scheduler 103 may determine to assign the logical processor to a different kind of physical processor from the processor to which the logical processor is assigned when the sleep instruction or the wait instruction is executed. Moreover, when a logical processor under a sleep instruction or a wait instruction resumes, the scheduler 103 may determine to assign the logical processor to a physical processor whose power consumption is lower than that of the physical processor to which the logical processor is assigned when the sleep instruction or the wait instruction is executed.

In the embodiment, a status holding flag holds information indicating an internal state of a logical processor, such as a wait state or a sleep state. If a processor has logical processor state holding registers, however, one or more of the logical processor state holding registers, instead of the status holding flag, may hold the information indicating the internal state.

In the embodiment, exemplary physical processors each different in kind are ones each different in manufacturing process and maximum operating frequency. The difference in kind, however, shall not be limited to these. For example, a multiprocessor system may include multiple processors each different in one or more of the following: pipeline structure; instruction issuing technique; maximum number of instructions to be issued in parallel; kind and presence or absence of an installed extension processing circuit such as floating-point unit (FPU), single instruction multiple data (SIMD), memory management unit (MMU), and dedicated CODEC; synthesis library; and capacity of installed cache.

Although an exemplary embodiment of the present disclosure has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

Furthermore, each of the processing units included in a multiprocessor according to the embodiment is typically implemented in the form of a large scale integration (LSI) which is an integrated circuit. The processing units may be made as separate individual chips, or as a single chip to include a part or all thereof.

Here the processing units are referred to as LSI; instead, the processing units may also be referred to as IC, System LSI, super LSI, and ultra LSI, depending on a difference in the degree of integration.

Moreover, the integration of a circuit shall not be limited to the LSI; instead, the circuit may be integrated in the form of a dedicated circuit or a general-purpose processor. In addition, it is also acceptable to use a Field Programmable Gate Array (FPGA) that is programmable after the LSI has been manufactured, and a reconfigurable processor in which connections and settings of circuit cells within the LSI are reconfigurable.

Furthermore, if an integrated circuit technology that replaces the LSI appears thorough the progress in the semiconductor technology or an other derived technology, that technology can naturally be used to carry out integration of the constituent elements.

The disclosed embodiment is an example in all respects, and therefore shall not be defined as it is. The scope of the present disclosure shall be defined not by the above descriptions but by claims, and shall include all modifications which are equivalent to and within the scope of the claims.

### INDUSTRIAL APPLICABILITY

One non-limiting and exemplary embodiment is applicable to multiprocessor systems. In particular, the embodiment is applicable to a multiprocessor system including multiple physical processors which have a mutually compatible instruction and each of which is different in kind.

1. A multiprocessor system which includes physical processors including at least one each of a first kind physical processor and a second kind physical processor, the physical processors having at least one mutually compatible instruction, and the multiprocessor system comprising:
a logical processor which is assigned to any one of the physical processors to be executed on the multiprocessor system; and
a scheduler which manages the assignment of the logical processor to one of the first kind physical processor and the second kind physical processor,
wherein the logical processor has a flag for holding information indicating an internal state of the logical processor, and the scheduler determines the assignment of the logical processor to one of the first kind physical processor and the second kind physical processor, based on presence or absence of an occurrence of a predetermined event and the information held in the flag.

2. the multiprocessor system according to claim 1,
wherein the logical processor further includes a selecting register which stores information indicating one kind out of the first kind physical processor and the second kind physical processor, and
the scheduler determines the assignment of the logical processor to one of the first kind physical processor and the second kind physical processor, based on presence or absence of a predetermined event, the flag, and the information stored in the selecting register.

3. The multiprocessor system according to claim 1,
wherein the scheduler determines the assignment of the logical processor to one of the first kind physical processor and the second kind physical processor, in the case where (i) the predetermined event occurs and (ii) the information held in the flag included in the logical processor indicates that the assignment of the logical processor to the any one of the physical processors is canceled by the logical processor executing at least one of a sleep instruction and a wait instruction.

4. The multiprocessor system according to claim 2,
wherein the scheduler determines, based on the information stored in the selecting register, the assignment of the logical processor to one of the first kind physical processor and the second kind physical processor, in the case where (i) the predetermined event occurs and (ii) the information held in the flag included in the logical processor indicates that the assignment of the logical processor to the any one of the physical processors is canceled by the logical processor executing at least one of a sleep instruction and a wait instruction.

5. The multiprocessor system according to claim 4,
wherein the scheduler determines the assignment of the logical processor to one of the first kind physical processor and the second kind physical processor having the one kind indicated in the selecting register, in the case where (i) the predetermined event occurs and (ii) the information held in the flag included in the logical processor indicates that the assignment of the logical processor to the any one of the processors is canceled by the logical processor executing at least one of the sleep instruction and the wait instruction.
